(19) United States
(12) Patent Application Publication
(10) Pub. No.: US 2024/0370879 A1
(43) Pub. Date: Nov. 7, 2024

(54) PROVIDING SUPPORT FOR COMPLYING WITH FISHING REGULATIONS

(71) Applicant: Fish Washington LLC, Bonney Lake, WA (US)

(72) Inventors: Edwin Snyder, Lakewood, WA (US); Erich Crawford, Buckley, WA (US); David Starkweather, Buckley, WA (US); Richard Armstrong, Great Falls, MT (US)

(21) Appl. No.: 18/311,098

(22) Filed: May 2, 2023

(51) Int. Cl. G06Q 30/018; G06Q 50/02

(52) U.S. Cl. CPC G06Q 30/018; G06Q 50/02

(57) ABSTRACT

A facility that uses a mobile device to provide support for complying with fishing regulations is described. The facility determines a present geographic location of the mobile device, and identifies one of a number of geographic regions for which fishing regulations are defined based on the determined present geographic location. The facility determines, among a number of fish, which can be caught and kept, by applying a representation of fishing regulations for the identified geographic region to a fishing context. The facility presents a visual indication of which of the plurality of fish can be caught and kept.

### BACKGROUND

Fishing is the activity of catching live fish in a body of water, either for food or as a sport. In many places, fishing is subject to legal regulations specifying which fish can be caught or kept.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram showing some of the components typically incorporated in at least some of the computer systems and other devices on which the facility operates.

FIG. 2 is flow diagram showing a process performed by the facility in some embodiments to ingest current fishing regulations in a number of geographic regions.

FIG. 3 is table diagram showing sample contents of a region table maintained by the facility.

FIG. 4 is table diagram showing sample contents of a fish table maintained by the facility to contain information about the types of fish for which the regulations specify fishing limitations.

FIG. 5 is a table diagram showing sample contents of a regulations table maintained by the facility in some embodiments to represent the fishing limitations of regulations retrieved by the facility.

FIG. 6 is a flow diagram showing a process performed by the facility in some embodiments to periodically transfer the contents of the tables used by the facility to represent the regulations to each mobile client device.

FIG. 7 is a flow diagram showing a process performed by the facility in some embodiments to operate the mobile device to provide support for complying with fishing regulations.

FIG. 8 is a display diagram showing sample contents of a display presented by the facility in some embodiments to display a location in corresponding region for which the facility will provide support for complying with fishing regulations.

FIG. 9 is a display diagram showing sample contents of a display presented by the facility in some embodiments to display a fish list in a first scrolled position.

FIG. 10 is a display diagram showing sample contents of a display presented by the facility in some embodiments to show a fish detail page for a fish that can be caught and kept.

FIG. 11 is a display diagram showing sample contents of a display presented by the facility in some embodiments to show the fish list in a second scrolled position.

FIG. 12 is a display diagram showing sample contents of a display presented by the facility in some embodiments to show a fish detail page for a fish that can't presently be caught and kept.

### DETAILED DESCRIPTION

The inventors have recognized that it can be challenging for people who fish to learn, understand, and apply the legal regulations that apply to their fishing. For example, the regulations are often distributed in difficult-to-understand language, from difficult-to-access sources. They often state regulations with respect to oddly-shaped geographic zones that must be looked up on paper maps, and correlated with the locations where someone plans to fish. In addition to location, the regulations can have myriad criteria including fish species, appearance, length, and weight; catch date; fishing equipment, such as hooks, lures, and baits; number of a species already taken during a particular period of time, such as a day or a year; etc. The regulations further contain little or no information about the appearances of the species they regulate, requiring additional cross-referencing to access pictures or descriptions of those species to be able to recognize them.

Finally, bringing this information along while fishing can involve bringing paper books, notebooks, or loose pages to the shore or on board a boat, where they can be damaged by or lost in the water.

In response to these recognitions, the inventors have conceived and reduced to practice a software and/or hardware facility for providing support for complying with fishing regulations (“the facility”).

In some embodiments, the facility provides a mobile app that an angler or other user (“user”) can install on a mobile device—such as a smartphone or tablet computer—that the user carries with them when fishing. In some embodiments, the facility uses a GPS locator functionality provided by or through the mobile device to determine the mobile device's geographic location, and uses it to select a fishing zone in which the mobile device is located. In some embodiments, the facility displays a map in which the mobile device's location is shown within the geographic region defined for the fishing zone. The facility accesses an internal representation of the regulations for that fishing zone, and uses them to display the salient aspects of those regulations in a usable way. In some embodiments, the facility's internal representation of regulations is cached in the mobile device, so that the facility can operate on this data even when the mobile device's data connection is inoperative, such as when the mobile device is out of range.

For example, in some embodiments, the facility displays a list of species commonly found in the fishing zone, in some cases showing each species' name together with a photo or illustration showing the species. The facility clearly indicates which of these species the user can properly catch and/or keep. In some embodiments, the facility's determination of which species the user can properly catch and/or keep is sensitive to information inputted by the user, such as the user's licensing status; the fishing permits the user has obtained and their effective dates; and other demographic information about the user that may affect their fishing status, such as age, tribal membership, eligibility for food assistance programs, etc. In some embodiments, the facility's determination is based on other kinds of information, such as the present date, the present weather conditions, the level of rainfall during a preceding period, a recently-reported water depth for the body of water in the fishing zone, etc.

In some embodiments, the facility permits the user to select one of the species to display a fish detail page, which can display additional details about the species; the requirements for catching and keeping it; the best techniques for locating and catching it; etc. In some embodiments, the facility tracks the user's catches, and/or reports them to a government agency designated to receive this information. In some embodiments, the facility automatically updates its internal representation of regulations to timely reflect changes to the regulations, such as by monitoring the state of the regulations.

By operating in some or all of the ways described above, the facility makes it easy to ascertain and apply the regulations that apply to their present location, even as they move beyond the geographic areas where they set out to fish, and even as they move out of coverage areas for the mobile device's data connection.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by caching its internal representation of regulations on the mobile device, the facility avoids the extra data traffic of having to download the regulations in their original, less compressed form, and the extra data traffic of having to download them repeatedly at times when they have not changed from the last-downloaded version. This can further preserve the supply of energy stored in the mobile device's battery, making the mobile device usable for longer periods between recharging, and extending its use on a fishing trip for executing the facility, and for other purposes like capturing photos and videos, staying in contact with friends and family, etc.

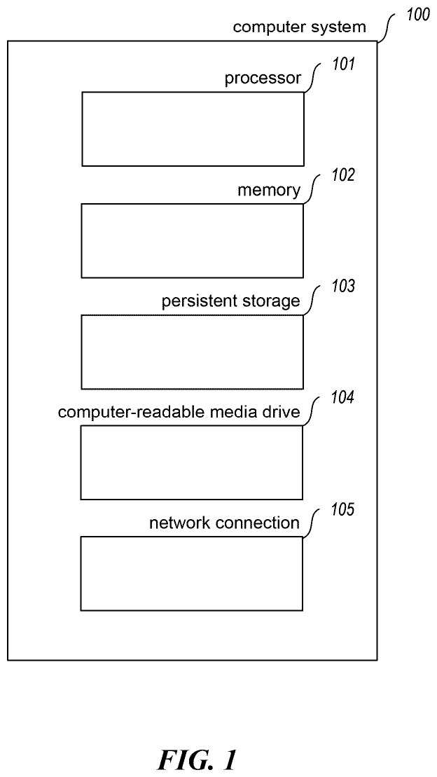

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

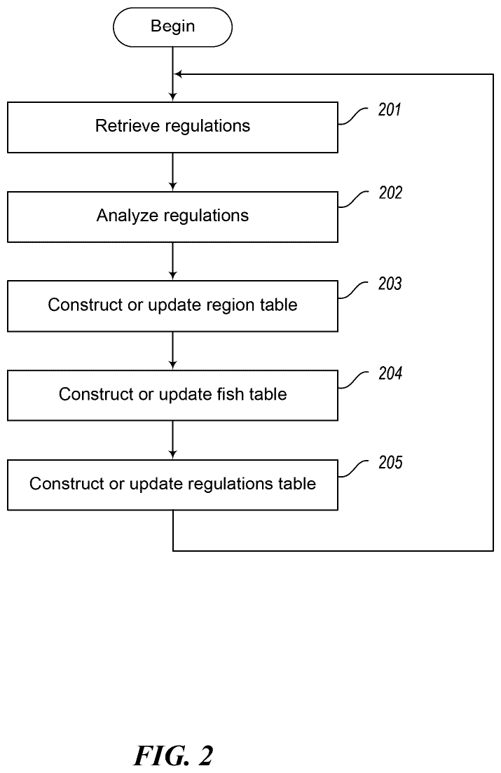

FIG. 2 is flow diagram showing a process performed by the facility in some embodiments to ingest current fishing regulations in a number of geographic regions. In various embodiments, these are fishing regulations that are effective for different geographic regions in, for example, a city, county, metropolitan area, state, or multiple states. In act 201, the facility retrieves the regulations from their source, such as from the government agency responsible for producing and/or distributing them. In some embodiments, the facility retrieves regulations from multiple different sources for different regions. In some embodiments, the facility retrieves the regulations by calling an API exposed by the source of regulations. In some embodiments, the facility impersonates a user visiting a webpage published by the regulation source and either downloads or scrapes the regulations from that website.

In act 202, the facility analyzes the regulations in order to, for each of a number of regions, for each of a number of fish types, extract limitations on catching and keeping fish of those fish types in those regions. As will be seen further below, these limitations may be of a wide variety of types, such as “fishing seasons” having a starting date and end date each year, “fishing hours” having a starting time and finishing time each day, a “maximum take” specifying a maximum number of fish of the type that can be caught and kept during a period of time, such as a day, week, month, or year; a minimum length, weight, or other size attribute; a color; structural attributes such as the presence or absence of certain fins; the possession of particular fishing permits or licenses; other attributes of the angler such as age, sex, income level, tribal membership, enrollment in food assistance programs, etc. As is discussed below, the facility populates the limitation information extracted from the regulations in act 202 into a number of tables constituting its representation of the regulations.

In act 203, the facility constructs or updates a region table that enumerates the regions for which regulations have been retrieved, assigns them a region ID, and stores a definition of the region that can be used to determine whether particular locations are within the region.

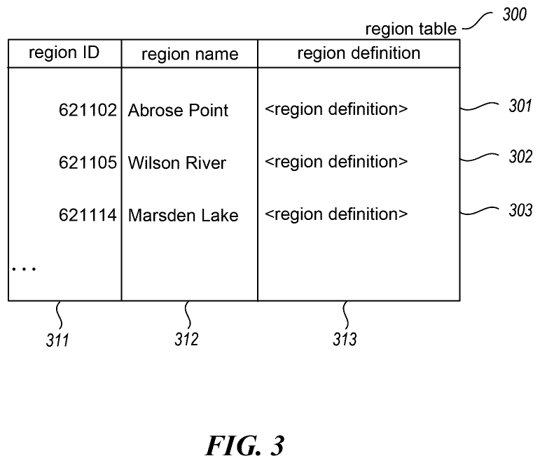

FIG. 3 is table diagram showing sample contents of a region table maintained by the facility. The region table 300 is made up of rows each representing a different region for which the regulations specify fishing limitations, such as rows 301-303. Each row is divided into the following columns: a region ID column 311 containing a region ID that uniquely identifies the region to which the row relates in the region table; a region name column 312 containing a textual name for the region; and a region definition column 313 containing a definition for the region usable to determine whether a particular location is within the region. In various embodiments, the region definition takes a variety of forms, including an ordered list of vertices of a polygon that define the region or approximate the region; a list of blocks—such as squares—that together define or approximate the region defining information for a circle or ellipse that defines or approximates the region; etc. For example, row 301 indicates that a region having region name Ambrose Point is assigned region ID 621102, and has the definition occurring at the intersection of row 301 with column 313.

While FIG. 3 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

Returning to FIG. 2, in act 204, the facility constructs or updates a fish table containing information about the fish types for which the regulations specify fishing limitations. In various embodiments, the facility identifies fish types in a variety of ways, such as by their order, family, genus, species, common name, fishmonger's name, etc.

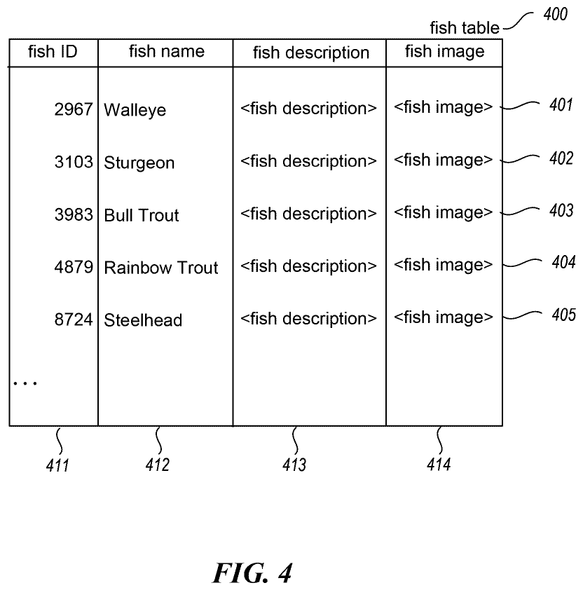

FIG. 4 is table diagram showing sample contents of a fish table maintained by the facility to contain information about the types of fish for which the regulations specify fishing limitations. The fish table 400 is made up of rows, such as rows 401-405, each corresponding to a different type of fish. Each row is divided into the following columns: a fish ID column 411 containing an identifier uniquely identifying the fish type in the fish table; a fish name column 412 containing a textual name for the fish; a fish description column 413 containing a textual description for the fish; and a fish image column 414 containing an image of the fish. For example, row 401 indicates that walleyes have been assigned fish ID 2967, have the fish description that occurs at the intersection of row 401 with column 413, and have the fish image that is at the intersection of row 401 and column 414. In some embodiments, the facility uses each fish name to automatically retrieve an existing photo or illustration of the fish from the Internet, or generate a new image of the fish using a generative Al tool.

Returning to FIG. 2, in act 205, the facility constructs or updates a regulations table representing the retrieved regulations in terms of the regions and fish documented in the region table and fish table, respectively. After act 205, the facility continues at a later time in act 201 to repeat the process of retrieving regulations in order to capture revisions to regulations, and/or retrieve regulations for other geographic areas. In some embodiments (not shown), the facility registers to be notified by particular jurisdictions when their fishing regulations are updated, and performs the retrieving in response to notifications received in connection with these registrations.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

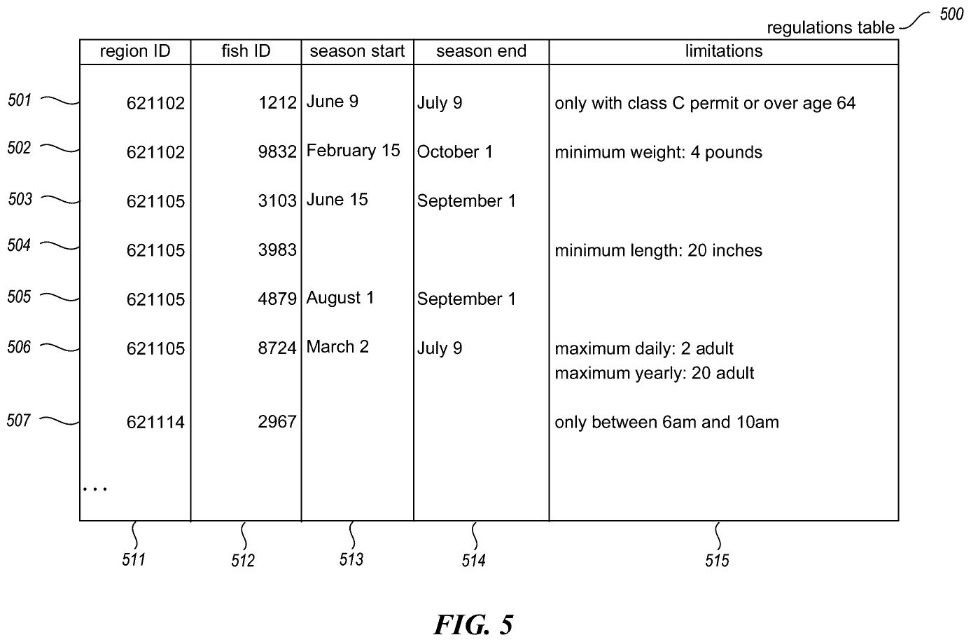

FIG. 5 is a table diagram showing sample contents of a regulations table maintained by the facility in some embodiments to represent the fishing limitations of regulations retrieved by the facility. The regulations table 500 is made up of rows, such as rows 501-507, each corresponding to the limitations for a different combination of region and fish. Each row is divided into the following columns: a region ID column 511 containing the region ID for the region identifying the region's row in the region table; a fish ID column 512 containing a fish ID identifying the fish's row of the fish table; a season start column 513 and a season end column 514 containing, respectively, dates marking the beginning and end of the season during which the fish can be caught and kept in the region; and a fishing limitations column 515 containing limitations on catching and keeping the fish in the region that extend beyond the season documented in columns 513 and 514. For example, row 506 indicates that, in the region corresponding to region ID 621105 (the Wilson River region shown in row 302 of the region table), the fish having fish ID 8724 (steelhead, shown in row 405 of the fish table) can be caught and kept during a season that begins on March 2 and ends on July 9, and that no more than two adult steelhead can be caught in this region in a single day, and no more than twenty adult steelhead can be caught in this region in the same year. Additionally, row 507 shows that, in the region having region ID 621114 (the Marsden Lake region in row 303 of the region table) the fish having fish ID 2967 (walleye, shown in row 401 of the fish table) can be caught at any time of year, but only between the hours of 6 a.m. and 10 a.m.

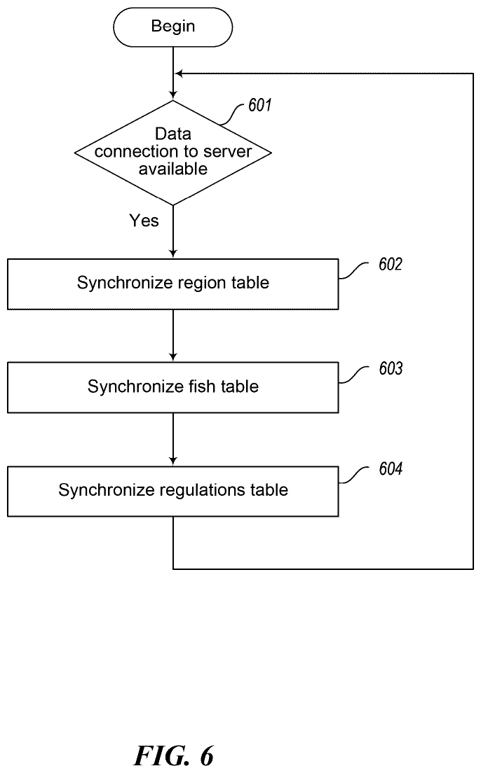

FIG. 6 is a flow diagram showing a process performed by the facility in some embodiments to periodically transfer the contents of the tables used by the facility to represent the regulations to each mobile client device. In some embodiments, the facility performs this process in each mobile device. In act 601, if a data connection to the server is available—such as a wireless cellular network connection, a wireless Wi-Fi connection, a wired Internet connection, etc.—then the facility continues in act 602. In act 602, the facility synchronizes the mobile client's copy of the region table with an authoritative version of the region table on a server. At a time when no region table is contained by the mobile client, the synchronization of act 602 involves simply copying the region table from the server to the mobile device. In the situation where the mobile device already has a copy of the region table, the facility uses an efficient way to resolve differences between the contents of the region table on the client and the region table on the server in favor of those on the server. For example, in some embodiments, the facility uses a version number or hash value to determine whether there are any differences between the server and client's version of the region table, and only if so, transfers an entire copy of the server's region table to the client. In some embodiments, the facility performs this conditional transfer process at a lower level of granularity, such as at the level of each individual row of the region table. In some embodiments, only a proper subset of the rows of the server's region table are synchronized to the client's region table, such as those that are in a geographic area—such as a state—where the mobile device is located, or where the user of the mobile device has indicated they intend to fish.

In acts 603 and 604, the facility synchronizes the fish table and regulations table from the server to the client in a manner similar to that described above with respect to act 602. After 604, the facility continues in act 601 to await its next opportunity for data connection and synchronization.

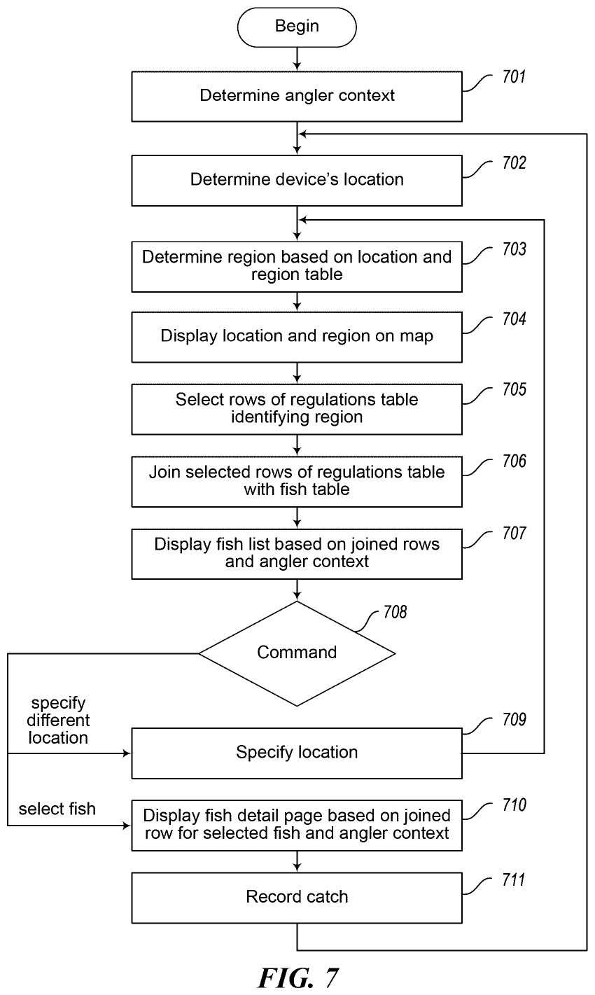

FIG. 7 is a flow diagram showing a process performed by the facility in some embodiments to operate the mobile device to provide support for complying with fishing regulations. In act 701, the facility determines the angler context of the user using the mobile device. In various embodiments, the angler context determined the facility in act 701 contains a variety of information used to assess compliance with the fishing limitations imposed by regulations, such as the number of different types of fish already caught and their dates; current licensing and permitting status; demographic information that may affect fishing status such as age, income level, tribal membership, eligibility for food assistance programs, etc.

In act 702, the facility determines the geographic location of the device, such as by using a GPS subsystem of the mobile device; Wi-Fi, Bluetooth, and/or cell tower location-determination systems; photographic landscape recognition; etc. In act 703, the facility determines a region based on the current location and the region table. In some cases, the location used by the facility in act 703 is the location determined for the device in act 702, while, as will be seen below, in some cases this current location is manually specified by the user in act 709. In some embodiments, act 703 involves identifying a most likely region, including, for example, selecting a region that is nearest the location, or most easily reached from the location; selecting region near the location that is most likely to be fished-in by the user, such as a nearby region that contains the type of fish previously caught by the user, a region containing a body of water whose type—e.g., stream, river, pond, lake, frozen lake, shoreline, bay, open ocean, etc.—is typical of the user's earlier fishing, etc. In some embodiments, some regions may overlap, and multiple regions may simultaneously contain the current location, in which the case the facility applies regulations for both regions, or selects one of the regions such as on one or more of the bases identified above.

In act 704, the facility displays the current location and the region determined in act 703 on a map.

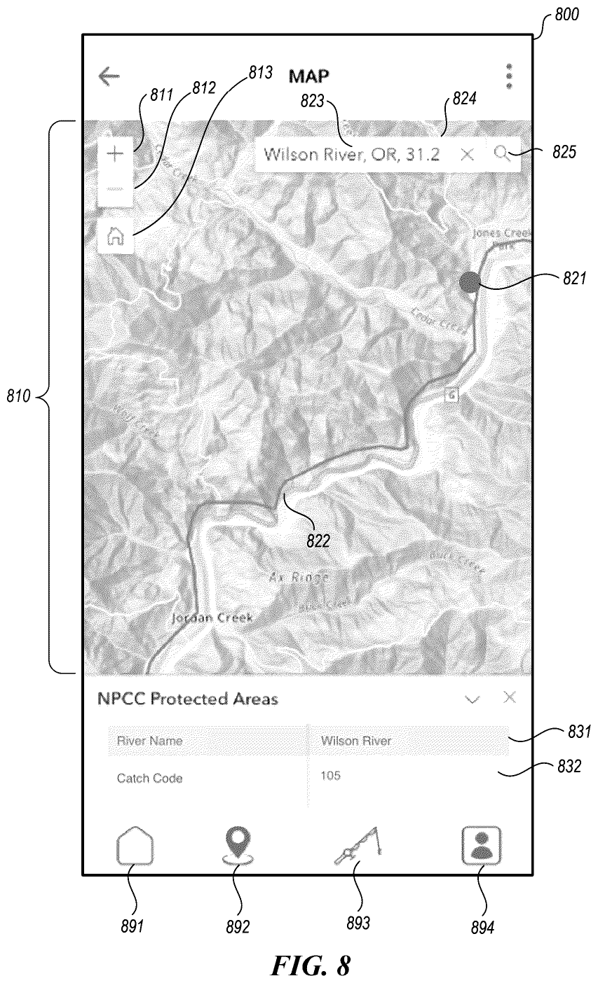

FIG. 8 is a display diagram showing sample contents of a display presented by the facility in some embodiments to display a location in corresponding region for which the facility will provide support for complying with fishing regulations. The display 800 includes a map 810 depicting a rectangular geographic area. The map includes controls 811 and 812 to zoom in and out, respectively of the geographic area shown in the map, as well as a control 813 that the user can activate in order to resynchronize the current location shown in the map (see below) with the device's location. Within the map, a current location indication 821 shows the current geographic location relative to the geographic area shown in the map. Further, a region indication 822 shows the geographic region identified in connection with the current location, for which the facility will provide support for complying with regulations. Here, the region indication is shown as a thick blue line that follows the shape of a river contained within the region. In some embodiments (not shown), the facility displays a region indication that, rather than being intersected with a fishing area as shown, includes the entire contents of the defined region. The display further includes names 823 and 831 for the region, as well as a catch code 832 associated by the regulations with the region. The display also includes a search control 825 that the user can activate in order to search for a different region or location. Finally, the user can pan the map by dragging a finger across it in order to display adjacent geographic areas. The display contains further controls 891-894 that the user can activate in order to perform additional actions.

While FIG. 8 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc. In various embodiments, the facility uses a variety of colors and/or patterns to display visual elements other than those shown in the display diagrams, including such visual elements as current fishing region and positive and negative indications of fish that can be caught and kept.

Returning to FIG. 7, in act 705 the facility selects rows of the regulation table that identify the region determined in act 703. From the region table shown in FIG. 3, it can be seen that the Wilson River region shown in the example depicted in FIG. 8 has region ID 621105. In the regulations table shown in FIG. 5, it can be seen that rows 503-506 identify this region ID for the Wilson River region. Accordingly, in the example, it is these four rows of the regulations table that the facility selects in act 705.

In act 706, the facility joins the rows of the regulations table selected in act 705 with the fish table. Returning to the example, selected row 503 contains the fish ID 3103. In the fish table shown in FIG. 4, it can be seen that this fish ID is contained in row 402 of the fish table. Accordingly, the act of joining row 402 of the fish table to selected row 503 of the regulations table adds the intersection of columns 412-414 of the fish table with row 402 to row 503 of the regulations table—i.e., the fish name Sturgeon, and the fish description and fish image contained by row 402. The facility similarly joins row 403 of the fish table to row 504 of the regulations table; row 404 of the fish table to row 505 of the regulations table; and row 405 of the fish table to row 506 of the regulations table.

In act 707, the facility displays a user interface construct called a fish list based upon the joined rows produced in act 706 and the angler context determined in act 701.

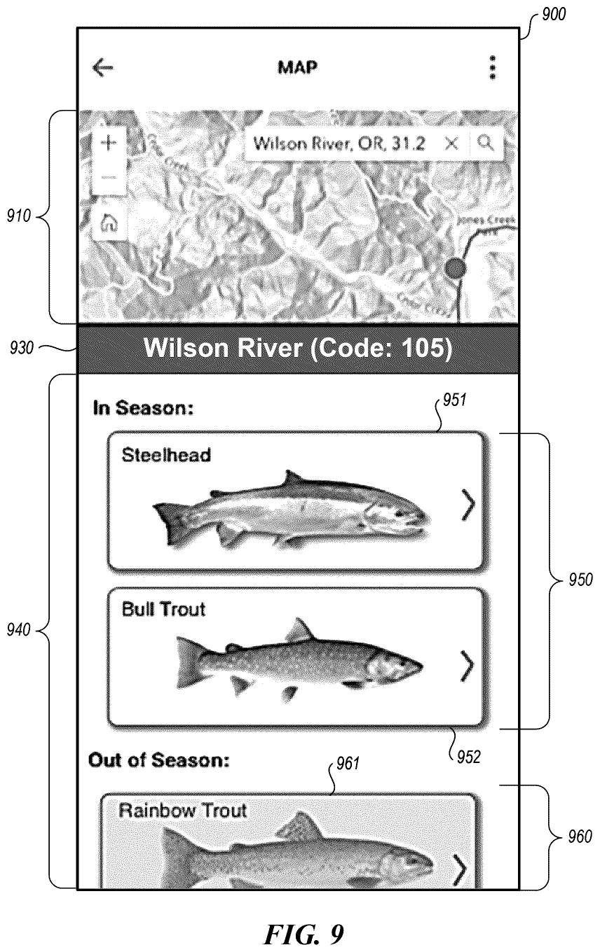

FIG. 9 is a display diagram showing sample contents of a display presented by the facility in some embodiments to display a fish list in a first scrolled position. The display 900 includes a shrunken version 910 of the map shown in FIG. 8, and an identification 930 of the region for which the fish list is displayed. The fish list 940 includes a first section 950 identifying fish that can be caught and kept by the angler in the region based on the angler context. In particular, these eligible fish are shown by positive indication 951 for steelhead, and positive indication 952 for bull trout. It can be seen that these positive indications include green elements in their color scheme. The user can select any of these positive indications, such as by touching or clicking on the indication, in order to display a fish detail page containing additional information about the fish and any limitations on catching or keeping it. The display also includes a second section 960 showing fish commonly present in the region that can't presently be caught and kept based upon the angler profile. A first negative indication 961 is visible in the second section, for rainbow trout which cannot presently be caught and kept based on the angler context. It can be seen that these negative indications include red elements in their color scheme. The user can scroll the page in order to see additional negative indications in the second area 960, such as by dragging upward within the fish list.

Returning to FIG. 7, while the fish list is displayed, the user can issue a command. In act 708, if the command is to specify a different location for which the facility is to provide support for complying with fishing regulations, then the facility continues in act 709; if the command is to select a fish in the fish list—such as by tapping on it—then the facility continues in act 710. In act 709, the user specifies a new location, such as by scrolling, and/or zooming the map, tapping at a particular point on the map, and/or typing the name of a location or region into search box 825 shown in FIG. 8. In response to these interactions, the facility determines the geographic location specified by the user. After act 709, the facility continues in act 703 to determine a new current region based upon the location specified in at 709.

In act 710, where the user has selected a particular fish from the fish list, the facility displays a fish detail page based on the joined row produced in act 706 for the fish selected by the user, and the contents of the angler context.

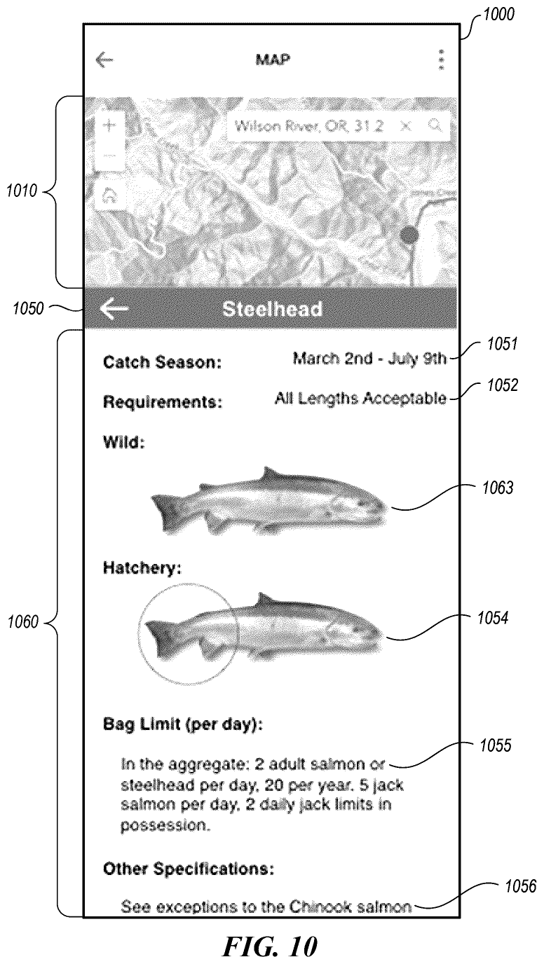

FIG. 10 is a display diagram showing sample contents of a display presented by the facility in some embodiments to show a fish detail page for a fish that can be caught and kept. In some embodiments, the facility displays fish detail page 1000 in response to the user selecting positive indication 951 for steelhead shown in FIG. 9. The display 1000 includes an abbreviated version 1010 of the region map. It identifies 1050 the fish to which the fish detail page relates as steelhead. The fish detail page further includes information 1060, including a catch season 1061 for this fish; the absence 1062 of any fish size limitations for this fish; visual indications 1063 and 1064 of the fin structure of steelhead originating from wild versus hatchery hatchings; a volume limitation 1065 for this fish; and additional information 1066.

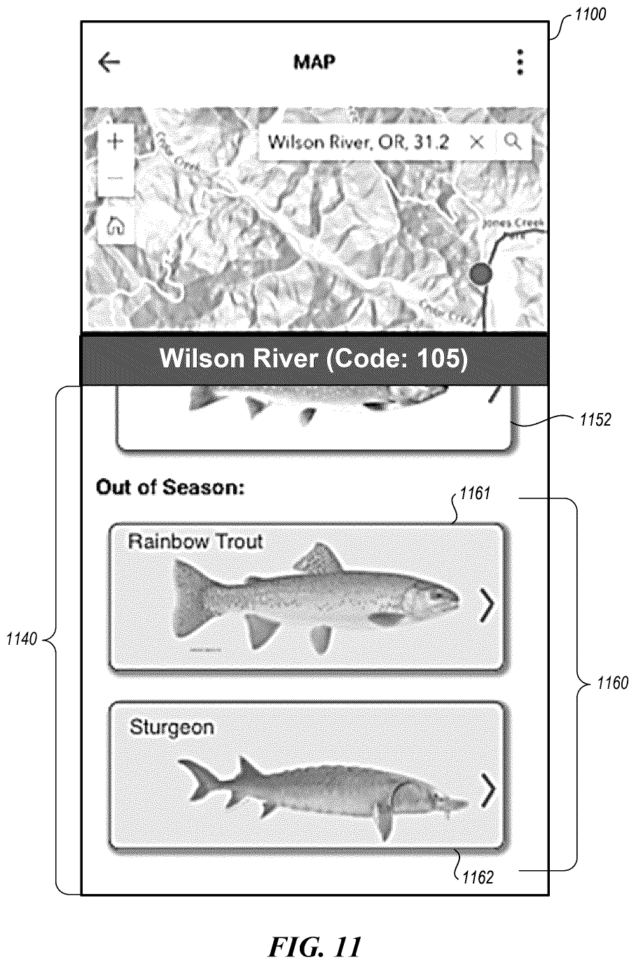

FIG. 11 is a display diagram showing sample contents of a display presented by the facility in some embodiments to show the fish list in a second scrolled position. In some embodiments, the facility presents this scrolled fish list display 1100 in response to user dragging upward on fish list 940 shown in FIG. 9. It can be seen that the scrolled fish list 1140 shown in FIG. 11 shows more fully than original fish list 940 shown in FIG. 9, the second section 1160 of the fish list, which can now be seen to contain two negative indications, 1161 for rainbow trout and 1162 for sturgeon. Similar to the first section, the user can select one of these negative indications to display the corresponding fish detail page.

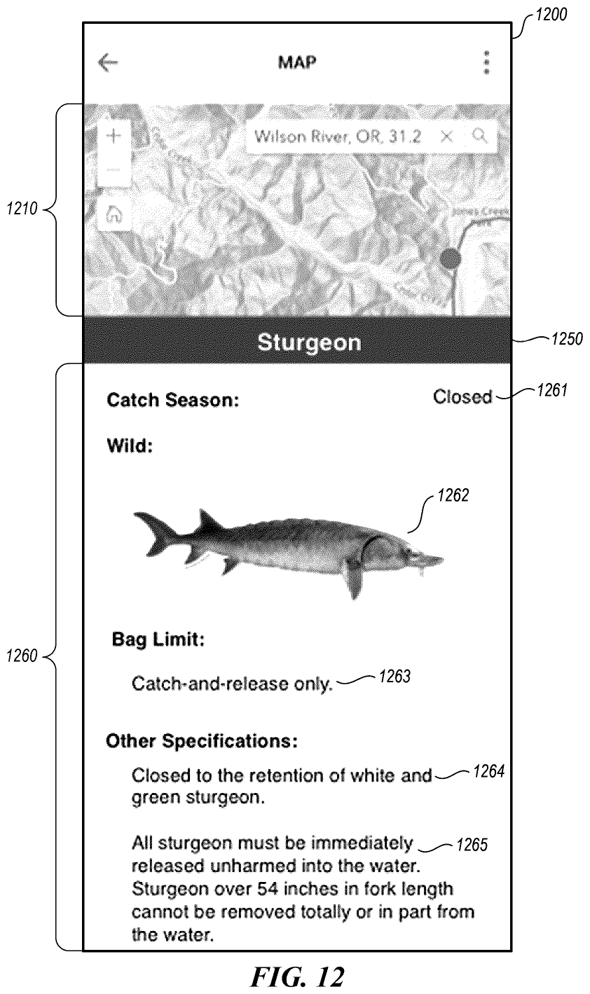

FIG. 12 is a display diagram showing sample contents of a display presented by the facility in some embodiments to show a fish detail page for a fish that can't presently be caught and kept. In some embodiments, the facility presents this fish detail page display 1200 in response to the user selecting the sturgeon negative indication 1162 shown in FIG. 11. The information 1260 shown in the item detail page for sturgeon 1250 includes an indication 1261 that its catch season is closed, i.e., the current date is not within the catch season window; an image 1262 of a wild sturgeon; an indication 1263 that any caught sturgeon can't presently be kept and must be released; an indication 1264 that white and green sturgeon can't presently be kept; and an indication 1265 regarding the need to immediately release caught sturgeon and a prohibition against removing sturgeon over 54 inches from the water.

Returning to FIG. 7, in some embodiments, the facility provides a mechanism for the user to indicate that they have caught a particular fish, such as by activating a control in the fish detail page for that fish (not shown). In response, in act 711, the facility records this catch in the angler context, where it can be used to determine whether future catches of the same fish or different fishes exceed a limit, and can also be used to automatically report and/or display the catches of the user, such as to a government fishing authority. After act 711, the facility continues in act 702.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A mobile computing device, comprising:
a data connection configured to receive a representation of fishing regulations for each of a plurality of geographic regions;
a geographic location determination subsystem configured to determine a present geographic location of the mobile device;
a region identification subsystem configured to identify one of the plurality of geographic regions based on the determined present geographic location;
a fish discrimination subsystem configured to determine, among a plurality of fish, which can be caught and kept, by applying the representation of fishing regulations for the identified geographic region to a fishing context; and
a display device configured to present a visual indication of which of the plurality of fish can be caught and kept in accordance with the determination.

2. The mobile computing device of claim 1, further comprising:
a memory configured to store the received representation of fishing regulations for use by the fish discrimination subsystem at times when the data connection is unable to receive the representation of fishing regulations.

3. The mobile computing device of claim 2 wherein the memory is further configured to store, for each of the plurality of fish, an image of the fish,
and wherein the display device is configured to present, as part of the visual indication of which of the plurality of fish can be caught and kept, images of the fish stored in the memory.

4. The mobile computing device of claim 1 wherein the display device is further configured to display a map in which the geographic region determined by the region identification subsystem is visually identified.

5. The mobile computing device of claim 1, further comprising:
a camera configured to capture an image of a fish; and
a fish identification subsystem that identifies one of the plurality of fish based on an image captured by the camera,
and wherein the display is configured to further present a name of the identified fish, and a visual indication of whether the identified fish can be caught and kept in accordance with the determination.

6. One or more instances of computer-readable media collectively storing a data structure, the data structure comprising:
a plurality of first entries, each first entry comprising:
first information identifying a geographic region to which the first entry relates;
second information identifying a fish type to which the first entry relates; and
third information specifying one or more restrictions on catching and keeping fish of the fish type identified by the second information in the geographic region identified by the first information,
such that the contents of the data structure are usable to determine, for a current geographic region identified the first information of each of a subset of the first entries, restrictions on catching and keeping fish of the fish types identified by the second information of the subset of the first entries in the current geographic region.

7. The one or more instances of computer-readable media of claim 6, the data structure further comprising:
one or more second entries, each second entry comprising:
an item of fishing context relating to determined restrictions on catching and keeping fish of the fish types identified by the second information of the subset of the first entries in the geographic region,
such that the contents of the data structure are further usable to determine which of the fish types identified by the second information of the subset of the first entries can be caught and kept in the current geographic region.

8. The one or more instances of computer-readable media of claim 6, the data structure further comprising:
a plurality of second entries, each second entry comprising:
a region definition for one of the geographic regions identified by first information of a portion of the first entries.

9. The one or more instances of computer-readable media of claim 6, the data structure further comprising:
a plurality of second entries, each second entry comprising:
for one of the fish types identified by at least one of the first entries, an image of a fish of the fish type.

10. The one or more instances of computer-readable media of claim 6, the data structure further comprising:
a plurality of second entries, each second entry comprising:
for one of the fish types identified by at least one of the first entries, a count of fish of the fish type caught and kept by a distinguished person.

11. One or more instances of computer-readable media collectively having contents configured to cause a mobile device to perform a method, the method comprising:
determining a present geographic location of the mobile device;
identifying one of a plurality of geographic regions for which fishing regulations are defined based on the determined present geographic location;
determining, among a plurality of fish, which can be caught and kept, by applying a representation of fishing regulations for the identified geographic region to a fishing context; and
presenting a visual indication of which of the plurality of fish can be caught and kept.

12. The one or more instances of computer-readable media of claim 11 wherein the fishing context includes a current date and time,
and wherein the representation of fishing regulations for the identified geographic region specifies date restrictions, time restrictions, or date and time restrictions for each of at least a portion of the fish of the plurality of fish.

13. The one or more instances of computer-readable media of claim 11 wherein the fishing context includes a license status, a permit status, or a license status and a permit status,
and wherein the representation of fishing regulations for the identified geographic region specifies license status, permit status restrictions, or license status and permit status restrictions for each of at least a portion of the fish of the plurality of fish.

14. The one or more instances of computer-readable media of claim 11 wherein the fishing context includes a catch count for each of at least a portion of the fish of the plurality of fish for a time period,
and wherein the representation of fishing regulations for the identified geographic region specifies a maximum catch count for the time period each of at least a portion of the fish of the plurality of fish.

15. The one or more instances of computer-readable media of claim 11, the method further comprising:
capturing an image of a fish;
identifying one of the plurality of fish based on the captured image; and
presenting a name of the identified fish, and a visual indication of whether the identified fish can be caught and kept in accordance with the determination.

16. The one or more instances of computer-readable media of claim 11, the method further comprising:
presenting a visual indication of which of the plurality of fish cannot be caught and kept.

17. The one or more instances of computer-readable media of claim 11, the method further comprising:
displaying a map in which the geographic region determined by the region identification subsystem and the determined present geographic location are visually identified.

18. The one or more instances of computer-readable media of claim 11, the method further comprising:
wirelessly retrieving a representation of fishing regulations for each of the plurality of geographic regions; and
caching the retrieved representation of fishing regulations in the mobile device.

19. The one or more instances of computer-readable media of claim 18, the method further comprising:
synchronizing the cached representation of fishing regulations with a version of the representation of fishing regulations that has been updated to reflect changes to the fishing regulations.

20. The one or more instances of computer-readable media of claim 11, the method further comprising:
for each of at least a portion of the plurality of fish for which visual indications are presented, receiving input during presentation of the visual indication for the fish that the fish has been caught; and
submitting a catch report to a governing authority identifying the fish for which input has received that the fish has been caught.
